(19) United States
(12) Patent Application Publication
(10) Pub. No.: US 2011/0102474 A1
(43) Pub. Date: May 5, 2011

(54) DISPLAY METHOD FOR COLOR SEQUENTIAL DISPLAY

(75) Inventors: Chia-Lin Liu, Taichung County (TW); Shian-Jun Chiou, Taipei City (TW); Huan-Ting Zhou, Taipei County (TW); Wen-Chih Tai, Taoyuan County (TW); Chi-Neng Mo, Taoyuan County (TW)

(73) Assignee: CHUNGHWA PICTURE TUBES, LTD., Taoyuan (TW)

(21) Appl. No.: 12/703,733

(22) Filed: Feb. 10, 2010

(30) Foreign Application Priority Data
Nov. 2, 2009 (TW) 98137162

(51) Int. Cl. G06F 3/038; G09G 5/10

(52) U.S. Cl. 345/690; 345/212

(57) ABSTRACT

A display method for a color sequential display is provided. The method includes the following steps. During a first frame period, a first color backlight is provided, and a plurality of scan lines is sequentially enabled according to a first scanning order. During a second frame period, a second color backlight is provided, and the scan lines are sequentially enabled according to a second scanning order. The first frame period and the second frame period are two neighboring frame periods, and the first scanning order and the second scanning order are reversed to each other.

### CROSS-REFERENCE TO RELATED APPLICATION

This application claims the priority benefit of Taiwan application serial no. 98137162, filed on Nov. 2, 2009. The entirety of the above-mentioned patent application is hereby incorporated by reference herein and made a part of specification.

### BACKGROUND OF THE INVENTION

1. Field of the Invention

The invention relates to a display technique, and more particularly to a display method of a color sequential display.

2. Description of Related Art

A conventional display is mainly constituted by a backlight module and a display panel having a color filter. Herein, the display panel is disposed on the backlight module. The color filter has filter units of three colors which are red, green, and blue, respectively. White light emitted by the backlight module passes through the red, green, and blue filter units to be converted into red light, green light, and blue light. The display can then display colorful images.

Nevertheless, the brightness of the white light emitted by the backlight module is reduced after passing through the red, green, and blue filter units. The time consumption and the cost of fabricating the color filter are unfavorable to the display. As a consequence, a color sequential display which does not require the disposition of the color filter has been proposed. In the color sequential display, a backlight module thereof emits light having different colors (i.e. red, green, and blue). The colored light then pass through a display panel that is not disposed with the color filter, so that color images are displayed by the display.

Generally, in a display method of the color sequential display, scan lines from the first scan line (located on the top of the display panel) to the last scan line (located at the bottom of the display panel) are enabled in sequence. The backlight module is in an off-state before the scan lines are enabled. After the last scan line has been enabled, the backlight module is turned-on to provide a light source to the display panel. Next, the backlight module is turned-off and actions aforementioned are repeated.

However, a time point of turning-on the backlight module is very close to a time point at which the actions of the enablement performed on the last few scan lines are stopped. Thus, liquid crystal molecules corresponding to the last few rows of pixel units can not spin to the correct tilting angles due to insufficient reaction time, such that intermixing results at the very bottom of the display image (that is, the image displayed by the last few pixel units).

### SUMMARY OF THE INVENTION

The invention is directed to a display method of a color sequential display. The display method is capable of reducing an intermixing occurred in the color sequential display.

The invention is directed to a display method of a color sequential display, and the display method includes the following steps. During a first frame period, a first color backlight is provided and a plurality of scan lines are enabled sequentially according to a first scanning order. During a second frame period, a second color backlight is provided and the scan lines are enabled sequentially according to a second scanning order. The first frame period and the second frame period are two neighboring frame periods. The first scanning order and the second scanning order are reversed to each other.

According to an embodiment of the invention, in the first scanning order, a time the (i−1)^{th} scan line is enabled is earlier than a time the i^{th} scan line is enabled, and in the second scanning order, the time the i^{th} scan line is enabled is earlier than the time the (i−1)^{th} scan line is enabled, where i is a positive integer.

According to an embodiment of the invention, the display method of the color sequential display further includes the following steps. During a third frame period, a third color backlight is provided and the scan lines are enabled sequentially according to the first scanning order. The first frame period, the second frame period, and the third frame period are three neighboring frame periods in sequence.

According to an embodiment of the invention, the first frame period, the second frame period, and the third frame period are respectively 1/180 second.

According to an embodiment of the invention, a color of the first color backlight is red, a color of the second color backlight is green, and a color of the third color backlight is blue.

According to an embodiment of the invention, the display method of the color sequential display further includes the following steps. During a fourth frame period, the first color backlight is provided and the scan lines are enabled sequentially according to the second scanning order. During a fifth frame period, the second color backlight is provided and the scan lines are enabled sequentially according to the first scanning order. During a sixth frame period, the third color backlight is provided and the scan lines are enabled sequentially according to the second scanning order. The fourth frame period, the fifth frame period, and the sixth frame period are three neighboring frame periods in sequence.

According to an embodiment of the invention, the display method of the color sequential display further includes the following steps. During a fourth frame period, a fourth color backlight is provided and the scan lines are enabled sequentially according to the second scanning order. The first frame period, the second frame period, the third frame period, and the fourth frame period are four neighboring frame periods in sequence. In one embodiment, the first frame period, the second frame period, the third frame period, and the fourth frame period are respectively 1/240 second. In another embodiment, a color of the first color backlight is red, a color of the second color backlight is green, a color of the third color backlight is blue, and a color of the fourth color backlight is white.

According to an embodiment of the invention, the color of the first color backlight includes a first color, a second color, and a third color. The color of the second color backlight includes the first color, the second color, and the third color. The color of the third color backlight includes the first color, the second color, and the third color.

According to an embodiment of the invention, a backlight having the first color is provided during a first sub-frame period of the first frame period. A backlight having the second color is provided during a second sub-frame period of the first frame period. A backlight having the third color is provided during a third sub-frame period of the first frame period. In addition, the backlight having the first color is provided during a fourth sub-frame period of the second frame period. The backlight having the second color is provided during a fifth sub-frame period of the second frame period. The backlight having the third color is provided during a sixth sub-frame period of the second frame period. Here, the first sub-frame period, the second sub-frame period, and the third sub-frame period are three neighboring sub-frame periods in sequence. The fourth sub-frame period, the fifth sub-frame period, and the sixth sub-frame period are three neighboring sub-frame periods in sequence.

According to an embodiment of the invention, the first sub-frame period, the second sub-frame period, the third sub-frame period, the fourth sub-frame period, the fifth sub-frame period, and the sixth sub-frame period are respectively 1/180 second.

According to an embodiment of the invention, the first color is red, the second color is green, and the third color is blue.

According to an embodiment of the invention, the color of the first color backlight further includes a fourth color and the color of the second color backlight further includes the fourth color, and the color of the third color backlight further includes the fourth color. In one embodiment, a backlight having the first color is provided during a first sub-frame period of the first frame period. A backlight having the second color is provided during a second sub-frame period of the first frame period. A backlight having the third color is provided during a third sub-frame period of the first frame period. A backlight having the fourth color is provided during a fourth sub-frame period of the first frame period. Moreover, the backlight having the first color is provided during a fifth sub-frame period of the second frame period. The backlight having the second color is provided during a sixth sub-frame period of the second frame period. The backlight having the third color is provided during a seventh sub-frame period of the second frame period. The backlight having the fourth color is provided during an eighth sub-frame period of the second frame period. The first sub-frame period, the second sub-frame period, the third sub-frame period, and the fourth sub-frame period are four neighboring sub-frame periods in sequence. The fifth sub-frame period, the sixth sub-frame period, the seventh sub-frame period, and the eighth sub-frame period are four neighboring sub-frame periods in sequence. In one embodiment, the first sub-frame period, the second sub-frame period, the third sub-frame period, the fourth sub-frame period, the fifth sub-frame period, the sixth sub-frame period, the seventh sub-frame period, and the eighth sub-frame period are respectively 1/240 second. In another embodiment, the first color is red, the second color is green, the third color is blue, and the fourth color is white.

In light of the foregoing, in the display method of the color sequential display according to the invention, the intermixing occurred in the color sequential display is reduced by the reversed scanning order of the scan lines within two neighboring frame periods.

In order to make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic partial cross-sectional view of a color sequential display according to an embodiment of the invention.

FIG. 2 is a schematic partial top view illustrating an active device array substrate in FIG. 1.

FIG. 3 is a flow chart of a display method of a color sequential display according to an embodiment of the invention.

FIG. 4 is a driving waveform of a color sequential display according to an embodiment of the invention.

### DESCRIPTION OF EMBODIMENTS

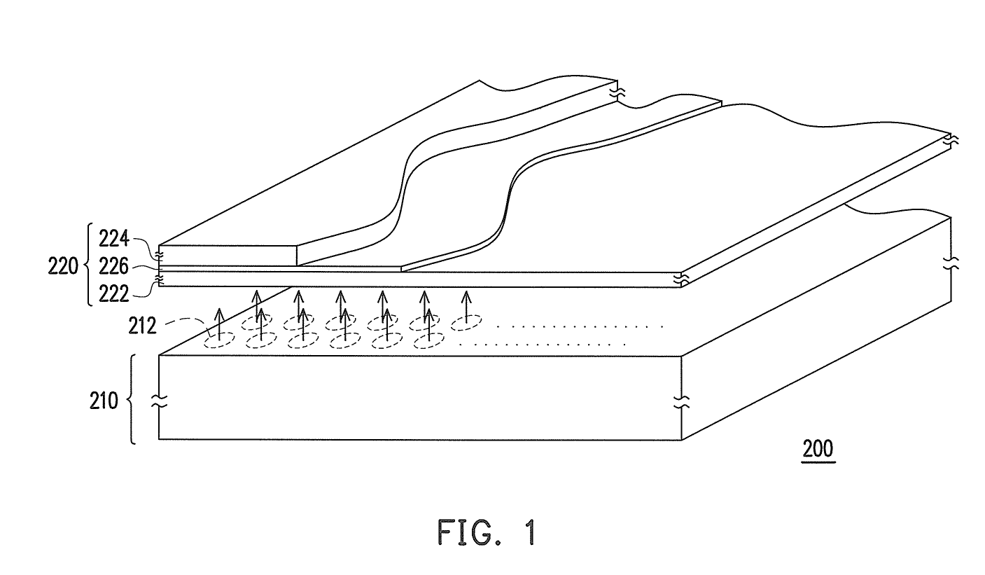

FIG. 1 is a schematic partial cross-sectional view of a color sequential display according to an embodiment of the invention. Referring to FIG. 1, a color sequential display 200 of the present embodiment includes a backlight module 210 and a display panel 220. The display panel 220 is disposed on the backlight module 210. The display panel 220 includes an active device array substrate 222, an opposite substrate 224, and a display medium layer 226 sandwiched between the active device array substrate 222 and the opposite substrate 224. The display medium layer 226, for example, is a liquid crystal layer.

In the present embodiment, a color filter may not be disposed in the display panel 220. Moreover, by driving the backlight module 210, a color to be displayed by the color sequential display 200 can be shown. Furthermore, the backlight module 210 of the present embodiment includes a plurality of backlight sources 212. Herein, light emitted by the backlight sources 212 has various colors. Therefore, the colorful images are displayed after the colored light passes through the display panel 220 which is not disposed with the color filter. In the following embodiment, a portion of the backlight sources 212 is assumed to emit red light, another portion of the backlight sources 212 is assumed to emit green light, and the remaining portion of the backlight sources is assumed to emit blue light.

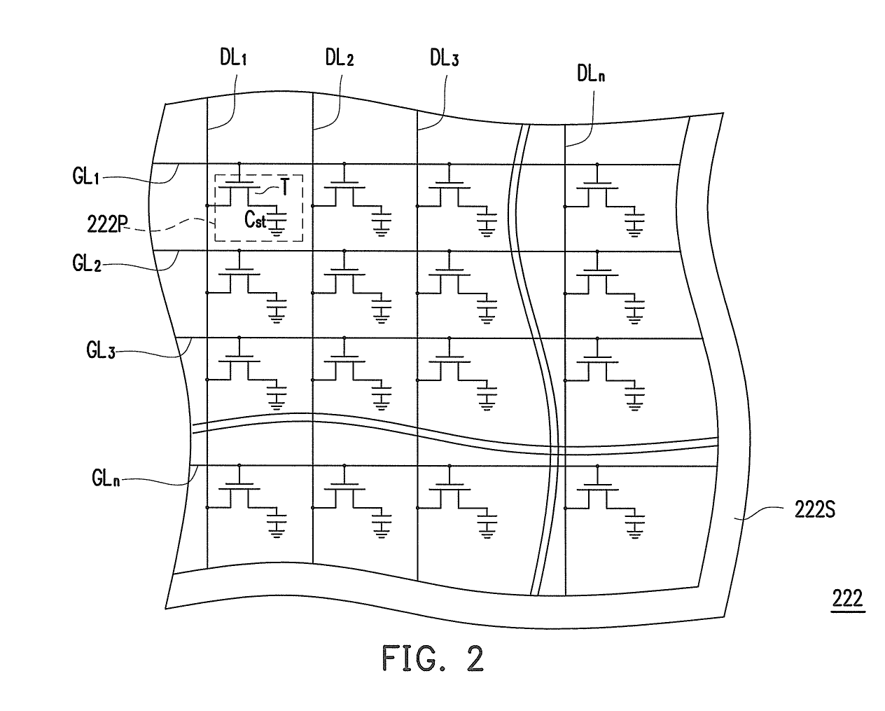

FIG. 2 is a schematic partial top view illustrating an active device array substrate in FIG. 1. Referring to FIG. 2, the active device array substrate 222 of the present embodiment includes a substrate 222S and a plurality of scan lines GL₁, GL₂, GL₃, . . . , GLₙ, a plurality of data lines DL₁, DL₂, DL₃, . . . , DLₙ, and a plurality of pixel units 222P disposed on the substrate 222S. Each pixel unit 222P is electrically connected to the corresponding scan line and the corresponding data line through an active device T disposed in the pixel unit 222P. Generally, each pixel unit 222P is further disposed with a storage capacitor Cst to enhance the display quality of the color sequential display 200 (illustrated in FIG. 1).

It should be noted that the color sequential display 200 of the present embodiment and the display panel 220 thereof further include other components as well. Other components are omitted in FIG. 1 and FIG. 2 for the convenience of illustration in the following embodiments.

In the following description, the display method of the color sequential display 200 of the present embodiment is exemplified. However, the invention is not limited to the embodiments illustrated below.

### First Embodiment

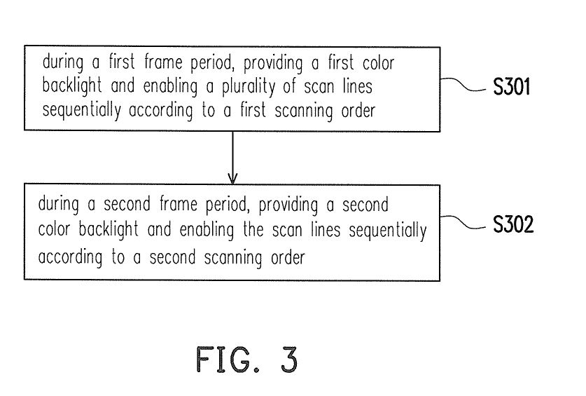

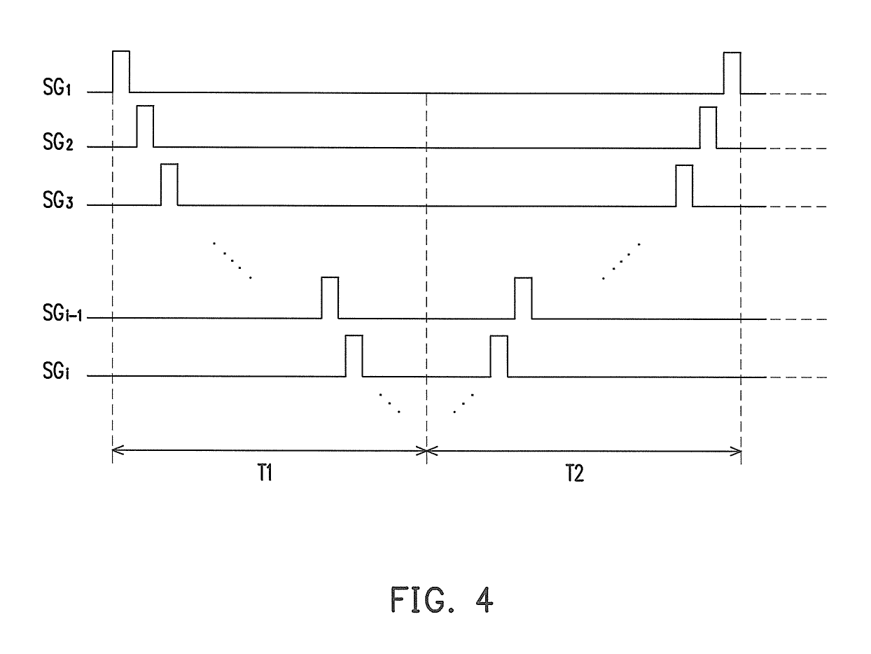

FIG. 3 is a flow chart illustrating a display method of a color sequential display according to an embodiment of the invention. FIG. 4 illustrates a driving waveform of a color sequential display according to an embodiment of the invention. Referring to FIG. 2, FIG. 3, and FIG. 4, SG₁, SG₂, SG₃, SGᵢ₋₁, and SGᵢ represent a scan signal waveform which is going to be performed on the scan line GL₁, a scan signal waveform which is going to be performed on the scan line GL₂, a scan signal waveform which is going to be performed on the scan line GL₃, a scan signal waveform which is going to be performed on the (i−1)^{th} scan line (not shown), and a scan signal waveform which is going to be performed on the i^{th} scan line (not shown) respectively. Moreover, “i” is a positive integer.

Firstly, in step S301, during a first frame period T1, the scan lines GL₁, GL₂, GL₃, . . . , GLₙ, are enabled sequentially. That is, the time the (i−1)^{th} scan line is enabled is earlier than the time the i^{th} scan line is enabled. More specifically, within the first frame period T1, the high level period of the SG₁ waveform is earlier than the high level period of the SG₂ waveform, the high level period of the SG₂ waveform is earlier than the high level period of the SG₃ waveform, and the high level period of the SGᵢ₋₁ waveform is earlier than the high level period of the SGᵢ waveform.

After the enablement performed on the scan lines GL₁, GL₂, GL₃, . . . , GLₙ during the first frame period T1 has finished, a first color backlight is provided. In the present embodiment, the first color backlight is a red backlight. The red backlight is provided, for example, by a portion of the backlight sources 212 which emits red light.

After the provision of the first color backlight has stopped, the scan lines GL₁, GL₂, GL₃, . . . , GLₙ are enabled again in the next frame period (referred as a second frame period T2 in the following). Particularly, in the present embodiment, the order of enabling the scan lines GL₁, GL₂, GL₃, . . . , GLₙ in the second frame period T2 and the order of enabling the scan lines GL₁, GL₂, GL₃, . . . , GLₙ in the first frame period T1 are reversed to each other.

More specifically, in step S303, during the second frame period T2, the scan lines GLₙ, . . . , GL₃, GL₂, GL₁ are enabled sequentially. That is, the time the i^{th} scan line is enabled is earlier than the time the (i−1)^{th} scan line is enabled. Within the second frame period T2, the high level period of the SGᵢ waveform is earlier than the high level period of the SGᵢ₋₁ waveform, the high level period of the SG₃ waveform is earlier than the high level period of the SG₂ waveform, the high level period of the SG₂ waveform is earlier than the high level period of the SG₁ waveform, and so on.

After the enablement performed on scan lines GLₙ, . . . , GL₃, GL₂, GL₁ during the second frame period T2 has finished, a second color backlight is provided. In the present embodiment, the second color backlight is a green backlight. The green backlight is provided, for example, by a portion of the backlight sources 212 which emits green light.

After the provision of the second color backlight has stopped, the scan lines GL₁, GL₂, GL₃, . . . , GLₙ are enabled again in the next frame period (referred as a third frame period in the following). It should be noted that in the present embodiment, the order of enabling the scan lines GL₁, GL₂, GL₃, . . . , GLₙ in the third frame period and the order of enabling the scan lines GL₁, GL₂, GL₃, . . . , GLₙ in the second frame period T2 are reversed to each other. However, the order of enabling the scan lines GL₁, GL₂, GL₃, . . . , GLₙ in the third frame period and the order of enabling the scan lines GL₁, GL₂, GL₃, . . . , GLₙ in the first frame period T1 are the same.

In other words, during the third frame period, the scan lines GL₁, GL₂, GL₃, . . . , GLₙ are sequentially enabled again in the present embodiment. That is, the time of enabling the (i−1)^{th} scan line is earlier than the time of enabling the i^{th} scan line. After the scan lines GL₁, GL₂, GL₃, . . . , GLₙ have finished the enablement performed during the third frame period, a third color backlight is provided. In the present embodiment, the third color backlight is a blue backlight. The blue backlight is provided, for example, by another portion of the backlight sources 212 which emits a blue light.

As aforementioned, the scanning orders of the scan lines GL₁, GL₂, GL₃, . . . , GLₙ in two neighboring frame periods are reversed with respect to each other. Therefore, if the time point of the backlight module 210 providing the colored light and the time point at which the enablement performed on the scan line GLₙ within one of the frame periods has stopped are close so as to affect the display quality of the last few rows of pixel units, the time point of the backlight module 210 providing the colored light then is close to the time point at which the enablement performed on the scan line GL₁ with the next frame period has stopped so as to improve the display quality of the last few rows of pixel units and vice versa. Compared to traditional display panels disclosed in related arts, the intermixing occurred in the last few rows of pixel units in the color sequential display 200 of the present embodiment can be greatly reduced to obtain superior display quality.

Based on the concept above-mentioned, the actions performed by the color sequential display 200 in the next three frame periods (referred as the fourth frame period, the fifth frame period, and the sixth frame period) can be speculated. During the fourth frame period, the scan lines GLₙ, . . . , GL₃, GL₂, GL₁ are enabled sequentially and the first color backlight (i.e. the red backlight) is provided after all the scan lines GL₁, GL₂, GL₃, . . . , GLₙ are enabled. During the fifth frame period, the scan lines GL₁, GL₂, GL₃, . . . , GLₙ are enabled sequentially and the second color backlight (i.e. the green backlight) is provided after all the scan lines GL₁, GL₂, GL₃, . . . , GLₙ are enabled. During the sixth frame period, the scan lines GLₙ, . . . , GL₃, GL₂, GL₁ are enabled sequentially and the third color backlight (i.e. the blue backlight) is provided after all the scan lines GL₁, GL₂, GL₃, . . . , GLₙ are enabled.

Thereafter, the color sequential display 200 repeats the actions in the first frame period T1 to the sixth frame period to display images. The first, the second, the third, the fourth, the fifth, and the sixth frame periods are respectively 1/180 second, for instance.

### Second Embodiment

A display method of the color sequential display 200 shown in FIG. 1 is illustrated in the following. The spirit of this embodiment is similar to that of the first embodiment, a main difference between the present embodiment and the first embodiment is that the backlight module 210 in the color sequential display 200 of the present embodiment further provides a fourth color backlight.

Referring to FIG. 1 and FIG. 2 simultaneously, in the present embodiment, the actions of enabling the scan lines GL₁, GL₂, GL₃, . . . , GLₙ in the first frame period to the fourth frame period can refer to the illustrations in the first embodiment. Here, the first color backlight (i.e. the red backlight), the second color backlight (i.e. the green backlight), and the third color backlight (i.e. the blue backlight) are respectively provided in the first frame period, the second frame period, and the third frame period, for example. However, during the fourth frame period, the fourth color backlight which emits white light is provided, for example. Practically, the white backlight can be attained by turning on all of the backlight sources 212 simultaneously for providing the red backlight, the green backlight, and the blue backlight.

Afterwards, the color sequential display 200 repeats the actions in the first frame period to the fourth frame period to display images. The first, the second, the third, and the fourth frame periods are respectively 1/240 second, for instance.

### The Third Embodiment

A display method of the color sequential display 200 shown in FIG. 1 is illustrated in the following. The spirit of this embodiment is similar to that of the first embodiment, a main difference between the present embodiment and the first embodiment is that each frame period in the present embodiment further includes a plurality of sub-frame periods. Herein, the backlights provided within different sub-frame periods of the same frame period have different colors.

Referring to FIG. 1 and FIG. 2 simultaneously, in the present embodiment, the actions of enabling the scan lines GL₁, GL₂, GL₃, . . . , GLₙ in the first frame period and the second period can refer to the illustrations in the first embodiment, and thus are not described hereinafter. Nevertheless, in the present embodiment, the first frame period is further divided into a first sub-frame period, a second sub-frame period, and a third sub-frame period. The second frame period is also further divided into a fourth sub-frame period, a fifth sub-frame period, and a sixth sub-frame period.

As aforementioned, the color of the color backlight provided during the first sub-frame period is red, the color of the color backlight provided during the second sub-frame period is green, and the color of the color backlight provided during the third sub-frame period is blue. On the other hand, the color of the color backlight provided during the fourth sub-frame period is red, the color of the color backlight provided during the fifth sub-frame period is green, and the color of the color backlight provided during the sixth sub-frame period is blue.

Thereafter, the color sequential display 200 repeats the actions in the first frame period and the second frame period to display images. The first and the second frame periods are respectively 1/60 second, for example. The first, the second, the third, the fourth, the fifth, and the sixth sub-frame periods are respectively 1/180 second, for instance.

It should be noted that in other embodiments, each frame period is divided into four sub-frame periods of approximately 1/240 second. The colors of the color backlight provided during the first three sub-frame periods are respectively red, green, and blue, and the backlight color provided during the fourth sub-frame period is white. In practice, the white backlight can be attained by turning on all of the backlight sources 212 simultaneously for providing the red backlight, the green backlight, and the blue backlight.

In principle, the scanning orders of the scan lines in two neighboring frame periods are reversed with respect to each other in the invention. Hence, in all the embodiments aforementioned, it is also assumed that in the scanning orders during the first frame period T1, the third frame period, and the fifth frame period, the time the i^{th} scan line is enabled is earlier than the time the (i−1)^{th} scan line is enabled. Furthermore, in the scanning orders during the second frame period T2, the fourth frame period, and the sixth frame period, the time the (i−1)^{th} scan line is enabled is earlier than the time the i^{th} scan line is enabled.

In summary, in the invention, the intermixing occurred in the last few rows of pixel units in traditional display panels is reduced by the reversed scanning order of the scan lines within two neighboring frame periods in the color sequential display. As a consequence, the color shift phenomenon is also reduced. Overall, the display method of the color sequential display according to the invention improves the display quality of the color sequential display.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A display method of a color sequential display, comprising:
during a first frame period, providing a first color backlight and enabling a plurality of scan lines sequentially according to a first scanning order; and
during a second frame period, providing a second color backlight and enabling the plurality of scan lines sequentially according to a second scanning order,
wherein the first frame period and the second frame period are two neighboring frame periods, and the first scanning order and the second scanning order are reversed to each other.

2. The display method of the color sequential display as claimed in claim 1, wherein in the first scanning order, a time an (i−1)^{th} scan line is enabled is earlier than a time an i^{th} scan line is enabled, and in the second scanning order, the time the i^{th} scan line is enabled is earlier than the time the (i−1)^{th} scan line is enabled, wherein i is a positive integer.

3. The display method of the color sequential display as claimed in claim 1, further comprising:
during a third frame period, providing a third color backlight and enabling the plurality of scan lines sequentially according to the first scanning order, wherein the first frame period, the second frame period, and the third frame period are three neighboring frame periods in sequence.

4. The display method of the color sequential display as claimed in claim 3, wherein the first frame period, the second frame period, and the third frame period are respectively 1/180 second.

5. The display method of the color sequential display as claimed in claim 3, wherein a color of the first color backlight is red, a color of the second color backlight is green, and a color of the third color backlight is blue.

6. The display method of the color sequential display as claimed in claim 3, further comprising:
during a fourth frame period, providing the first color backlight and enabling the plurality of scan lines sequentially according to the second scanning order;
during a fifth frame period, providing the second color backlight and enabling the plurality of scan lines sequentially according to the first scanning order; and
during a sixth frame period, providing the third color backlight and enabling the plurality of scan lines sequentially according to the second scanning order,
wherein the fourth frame period, the fifth frame period, and the sixth frame period are three neighboring frame periods in sequence.

7. The display method of the color sequential display as claimed in claim 3, further comprising:
during a fourth frame period, providing a fourth color backlight and enabling the plurality of scan lines sequentially according to the second scanning order, wherein the first frame period, the second frame period, the third frame period, and the fourth frame period are four neighboring frame periods in sequence.

8. The display method of the color sequential display as claimed in claim 7, wherein the first frame period, the second frame period, the third frame period, and the fourth frame period are respectively 1/240 second.

9. The display method of the color sequential display as claimed in claim 7, wherein a color of the first color backlight is red, a color of the second color backlight is green, a color of the third color backlight is blue, and a color of the fourth color backlight is white.

10. The display method of the color sequential display as claimed in claim 3, wherein a color of the first color backlight comprises a first color, a second color, and a third color, a color of the second color backlight comprises the first color, the second color, and the third color, and a color of the third color backlight comprises the first color, the second color, and the third color.

11. The display method of the color sequential display as claimed in claim 10, wherein the method of providing the first color backlight and the second color backlight comprises:
providing a backlight having the first color during a first sub-frame period of the first frame period;
providing a backlight having the second color during a second sub-frame period of the first frame period;
providing a backlight having the third color during a third sub-frame period of the first frame period;
providing the backlight having the first color during a fourth sub-frame period of the second frame period;
providing the backlight having the second color during a fifth sub-frame period of the second frame period; and
providing the backlight having the third color during a sixth sub-frame period of the second frame period,
wherein the first sub-frame period, the second sub-frame period, and the third sub-frame period are three neighboring sub-frame periods in sequence, and the fourth sub-frame period, the fifth sub-frame period, and the sixth sub-frame period are three neighboring sub-frame periods in sequence.

12. The display method of the color sequential display as claimed in claim 11, wherein the first sub-frame period, the second sub-frame period, the third sub-frame period, the fourth sub-frame period, the fifth sub-frame period, and the sixth sub-frame period are respectively 1/180 second.

13. The display method of the color sequential display as claimed in claim 11, wherein the first color is red, the second color is green, and the third color is blue.

14. The display method of the color sequential display as claimed in claim 10, wherein the color of the first color backlight further comprises a fourth color, the color of the second color backlight further comprises the fourth color, and the color of the third color backlight further comprises the fourth color.

15. The display method of the color sequential display as claimed in claim 14, wherein the method of providing the first color backlight and the second color backlight comprises:
providing a backlight having the first color in a first sub-frame period of the first frame period;
providing a backlight having the second color during a second sub-frame period of the first frame period;
providing a backlight having the third color during a third sub-frame period of the first frame period;
providing a backlight having the fourth color during a fourth sub-frame period of the first frame period;
providing the backlight having the first color during a fifth sub-frame period of the second frame period;
providing the backlight having the second color during a sixth sub-frame period of the second frame period,
providing the backlight having the third color during a seventh sub-frame period of the second frame period; and
providing the backlight having the fourth color during an eighth sub-frame period of the second frame period,
wherein the first sub-frame period, the second sub-frame period, the third sub-frame period, and the fourth sub-frame period are four neighboring sub-frame periods in sequence, and the fifth sub-frame period, the sixth sub-frame period, the seventh sub-frame period, and the eighth sub-frame period are four neighboring sub-frame periods in sequence.

16. The display method of the color sequential display as claimed in claim 15, wherein the first sub-frame period, the second sub-frame period, the third sub-frame period, the fourth sub-frame period, the fifth sub-frame period, the sixth sub-frame period, the seventh sub-frame period, and the eighth sub-frame period are respectively 1/240 second.

17. The display method of the color sequential display as claimed in claim 15, wherein the first color is red, the second color is green, the third color is blue, and the fourth color is white.
